(19) United States
(12) Patent Application Publication
(10) Pub. No.: US 2014/0253415 A1
(43) Pub. Date: Sep. 11, 2014

(54) INFORMATION SHARING BETWEEN INTEGRATED VIRTUAL ENVIRONMENT (IVE) DEVICES AND VEHICLE COMPUTING SYSTEMS

(71) Applicant: ECHOSTAR TECHNOLOGIES L.L.C., Englewood, CO (US)

(72) Inventors: Christofer Hardy, Cheyenne, WY (US); Thomas Allan Yarborough, Englewood, CO (US)

(73) Assignee: ECHOSTAR TECHNOLOGIES L.L.C., Englewood, CO (US)

(21) Appl. No.: 13/787,606

(22) Filed: Mar. 6, 2013

(51) Int. Cl. G06F 3/147

(52) U.S. Cl. CPC G06F 3/147
USPC 345/2.2

(57) ABSTRACT

Methods, systems and devices are described for sharing information between an integrated virtual environment (IVE) or other wearable computing device and a display system associated with an aircraft, automobile, boat, train, bus or other vehicle. As a user enters a vehicle with an IVE, the vehicle recognizes the IVE and transfers the data stream to a vehicle display. The IVE may also be disabled while it is present in the vehicle to prevent distraction to a driver or operator of the vehicle.

### TECHNICAL FIELD

The present disclosure generally relates to integrated virtual environment (IVE) or other wearable computing devices. More particularly, the following discussion relates to systems, methods and devices to improve compatibility between wearable computing devices and vehicle display systems.

### BACKGROUND

Mobile computing devices have become ubiquitous in recent years. Millions of consumers now carry mobile phones, tablet computers and other devices that are able to provide a wealth of immediate information to the user. Such information often includes messaging, voice or video communications, textual or graphical data, or even audio or video media streaming.

Consumers are now demanding even smaller devices with increased connectivity and processing power. In particular, there is intense interest in computers that are integrated into eyeglasses or other wearable devices. These so-called “integrated virtual environments” (IVEs) provide augmented reality, communications, media and/or other computing features in a device that can be conveniently and comfortably carried throughout the day. There is some concern, however, that too much attention could be focused on an IVE at some times or during some activities. If a user is operating a vehicle, for example, excessive focus on a media stream or other IVE presentation could be distracting to more urgent tasks, such as controlling the vehicle.

It is therefore desirable to build systems, devices and techniques for allowing a user to continue use of messaging or other IVE data even in situations where focusing attention on the IVE device itself could be undesirable. These and other desirable features and characteristics will become apparent from the subsequent detailed description and the appended claims, taken in conjunction with the accompanying drawings and this background section.

### BRIEF SUMMARY

Some embodiments provide methods executable by a vehicle display system to provide imagery intended for an integrated virtual environment (IVE) device on a display of a vehicle. The method suitably comprises detecting that the IVE device is in physical proximity to the vehicle, and when the IVE device is in physical proximity to the vehicle, providing a first message to the IVE device to thereby temporarily disable presentation of data on an IVE display of the IVE device and directing the presentation of the data on the display of the vehicle instead of on the IVE display.

Other embodiments provide a display management system to provide imagery on a display of a vehicle. The display management system suitably comprises a communications interface configured to receive data communications signals from an antenna and a controller. The controller is configured to identify an integrated virtual environment (IVE) device in physical proximity to the vehicle and, when the IVE device is in physical proximity to the vehicle, to instruct the IVE to disable its display and to instead provide content otherwise presented on the IVE as the imagery for presentation on the display of the vehicle.

Other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a system diagram showing an exemplary system in which IVEs are able to communicate with a vehicle display system;

FIG. 2 is a flowchart of an exemplary process to share content from an IVE to a vehicle display; and

FIG. 3 is a diagram of an exemplary process in which multiple IVEs communicate with a vehicle display system.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

According to various exemplary embodiments, displays provided by an integrated virtual environment device are temporarily suspended when the user is in relatively close physical proximity to a vehicle. Further, some or all of the information that would otherwise be displayed on the IVE device can be presented instead on a display that is associated with a vehicle. This allows users to continue receiving messages, enjoying a media stream and/or performing other functions ordinarily carried out using the IVE even though the user is controlling or riding in a vehicle.

These general concepts may be applied in any number of different settings. As a driver enters an automobile or truck, for example, the vehicle display system could automatically detect the presence of the driver's IDE device, and could automatically transfer imagery and/or data from the IDE to a dashboard or heads up display in the vehicle. This would allow the driver to continue viewing of messages or other content in a safer and less distracting manner than would otherwise be available from the IDE itself. Other embodiments could consider multiple passengers within a vehicle. A cabin entertainment system for an aircraft, for example, could transfer messaging, video or other data from a passenger's IDE to a seat-back entertainment system for more convenient viewing in the passenger's seat during flight. Additional details of these and other exemplary embodiments are set forth in more detail below.

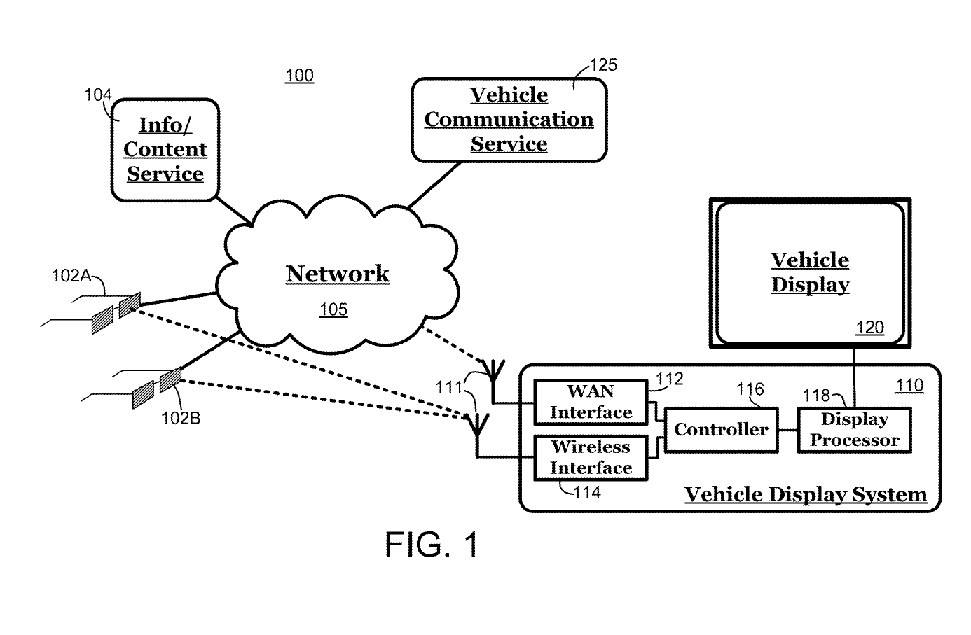

Turning now to the drawing figures and with initial reference to FIG. 1, an exemplary system 100 suitably includes a vehicle display system 112 that interacts with one or more integrated virtual environment (IVE) devices 102A-B. During normal operation, IVE devices 102A-B receive messages, media content or any other types of digital data from one or more content sources 104. This information is suitably formatted and presented on a display associated with the IVE device 102A-B. As the user enters (or otherwise comes into close proximity with) a vehicle, however, the display changes from the IVE 102A-B to a display 120 that is associated with the vehicle. In various embodiments, the vehicle display system 112 receives a data stream from the IVE 102 that is rendered to the user on the vehicle display 120 while the user is present in the vehicle. Other embodiments could perform a handoff procedure in which content from source 104 is provided to the vehicle display system 112 though a vehicle communication service 125. Other embodiments may be supplemented or otherwise modified in any manner.

IVE devices 102A-B are any sort of wearable computing devices capable of providing enhanced reality, media content or other information to the viewer. Examples of IVE devices 102A-B could include the GOOGLE GLASS products available from Google Inc. of Mountain View, Calif., although any number of other products could be equivalently used. Typically, IVE devices 102A-B augment the user's regular vision with computerized displays providing additional information about objects viewed, messages intended for the viewer, media content and/or any other data desired by the user. Each IVE 102A-B typically includes a suitable processor and memory for storing and executing software commands, along with a display for providing output to the user. Some IVE devices 102A-B could display generated imagery within a pair of eyeglasses, for example, or in a projection that is visible to the user, or in any other manner. Although FIG. 1 shows two IVE devices 102A-B for simplicity, in practice any number of devices could be provided within a practical system 100.

Vehicle display system 110 is a vehicle entertainment system, vehicle information system, or other computing system capable of providing visual presentations to operators and/or passengers of a vehicle. Typically, such visual presentations are made on a display 120 that is visible within the vehicle, such as a dashboard display, a heads up display (HUD), a helmet mounted display (HMD), or simply a flat panel or other display that is present anywhere within the vehicle. Vehicles could include (without limitation) aircraft, automobiles, trucks, boats, ships, bicycles, motorcycles, transit vehicles such as buses and trains, and/or any other vehicles as desired.

Display system 110 suitably includes a microprocessor, digital signal processor or other controller 116 that receives data inputs from one or more sources via one or more interfaces 112, 114. In the example illustrated in FIG. 1, display system 110 includes an interface 112 to a wide area network 105 such as the Internet, a cellular network, a satellite network or the like. Display system 110 is also shown with a second interface 114 that allows direct communication with IVE devices 102A-B. Such communications may be provided using any sort of relatively short range wireless communications or the like. Conventional WPAN/Bluetooth (IEEE 802.15) or ZIGBEE (IEEE 802.15.4) communications could be used, for example, as could any other standard or proprietary communications schemes. Interfaces 112, 114 may share one or more antennas 111 in some implementations, or separate antennas 111 may be provided to support different communications standards, frequency bands or the like.

Vehicle communications service 125 is any sort of backend service capable of supporting communications with one or more vehicle display systems 110. In practice, service 125 may incorporate a proxy or the like for obtaining content on network 105. Such content may be forwarded to display system 110 via network 105 or via a separate communications channel, such as a satellite link or cellular network, as desired.

As noted above, it is typically desirable to suspend data presentation using the IVE device 102A-B while the user is operating a vehicle, or when excessive attention on the device 102A-B could be detrimental. To that end, vehicle communications service 110 and IVE device 102 interact with each other to transfer the display of relevant information from the IVE display to the vehicle display 120 at appropriate times. When the user is operating the vehicle, for example, messages or other relevant information can be transferred from the user's IVE device 102 to a cockpit or dashboard display, to a HUD, or to any other display 120 located within the vehicle. Presentation can be returned to the IVE device 102 when the user exits the vehicle, when the vehicle is turned off, or at any other appropriate time.

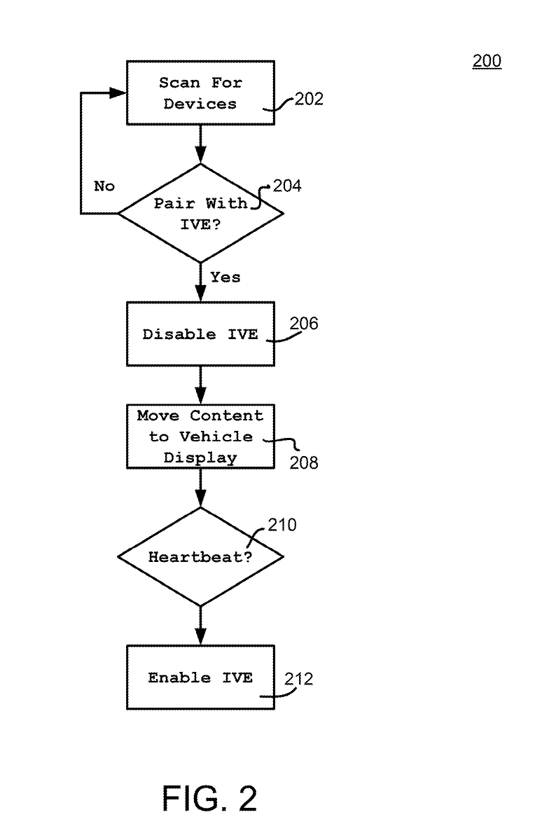

Turning now to FIG. 2, an exemplary process 200 to transfer displays of video imagery or other data from an IVE device 102 to a vehicle display 120 is described. Generally speaking, process 200 may be executed by controller 116 within the vehicle display system 110 (FIG. 1), or by other suitable processing circuitry as appropriate.

Vehicle display system 110 typically scans for IVE devices 102 that are in relatively close physical proximity (function 202). Scanning may be performed on any regular or irregular temporal basis, or may be initiated by the user in any manner. Various embodiments may use conventional IEEE 802.15 communications, for example, to locate IVE devices 102 that are operating within wireless range of the vehicle. When an IVE device 102 is located, then the device can be paired with the display system 110 as desired (function 204). Pairing may involve, for example, the user approving the connection with display system 110, or the pairing may be automated as desired. User approval may be obtained from the IVE 102, from buttons or other input features of vehicle display system 110, or any combination of inputs from the IVE 102 and display system 110 as desired.

When an IVE is paired with the display system 110, then display of imagery on the IVE display is suitably disabled (function 206). In various embodiments, the display system 110 transmits an instruction to the IVE 102 that initiates the suspension of further displays. In other embodiments, IVE 102 may be programmed (e.g., in software or firmware) to disable its own display when it is paired with a vehicle display system 110, as desired.

Content display is then transferred from the IVE 102 to the vehicle display 120 as desired (function 208). In various embodiments, video streams that would ordinarily be presented on the IVE display are instead streamed to the display system 110 for rendering on display 120. In such embodiments, IVE 102 is still involved in generating output imagery that is streamed or otherwise provided to display system 110 via interface 114 for presentation on display 120. Other embodiments may simply provide messages or other raw data processed at IVE 102 to the display system 110 so that display system 110 can generate output images on display 120 that incorporate the received data. Text messages, for example, could be provided in a relatively raw format from IVE 102 to display system 110 via interface 114 in some embodiments. Display system 110 would then format the received raw data into still or moving imagery that could be provided on display 120.

In still other embodiments, display system 110 performs an actual handoff of data streaming from IVE 102 so that data is provided directly to the display system 110 without first passing through the IVE 102. Such embodiments may make use of a separate interface 112 to a satellite, mobile telephone or other source of data rather than receiving data directly from the IVE via interface 114. The handoff could be performed in any manner; in various embodiments, a backend service 125 suitably acts as a proxy on network 105 to retrieve messaging or other data directly from the content source 104. Backend service 125 could also monitor connection status between the IVE 102 and the display system 110 so that messaging or other data streams can be restored to the IVE after pairing with the display system 110 has ended. Other embodiments could operate in any number of alternate but equivalent ways to achieve similar results.

Display could be returned to the IVE 102 in any manner (function 212). In various embodiments, heartbeat messages are transmitted between the display system 110 and the IVE 102 on a regular temporal basis (e.g., every few seconds or so) to ensure that the IVE 102 is still present within the vehicle (function 210). Heartbeat messages may not be needed at times that the IVE 102 is otherwise engaged in active communications with the display system 110. If the IVE 102 is providing a video stream or steady stream of data, for example, then heartbeat messages may not be needed. If display system 110 stops receiving heartbeat messages from IVE 102 after a period of relative inactivity, however, it can be determined that the IVE 102 is no longer present in proximity to the vehicle. The IVE display may be released at that time so that data presentation can continue. Similarly, the presentation of IVE data on vehicle display 120 can be discontinued as desired. Equivalent embodiments could monitor heartbeat messages from within the IVE device 102. In such embodiments, the IVE 102 would reinstate its own display when it was determined that the vehicle display system 110 was no longer present, or no longer in physical proximity. Other embodiments could be modified or enhanced as desired.

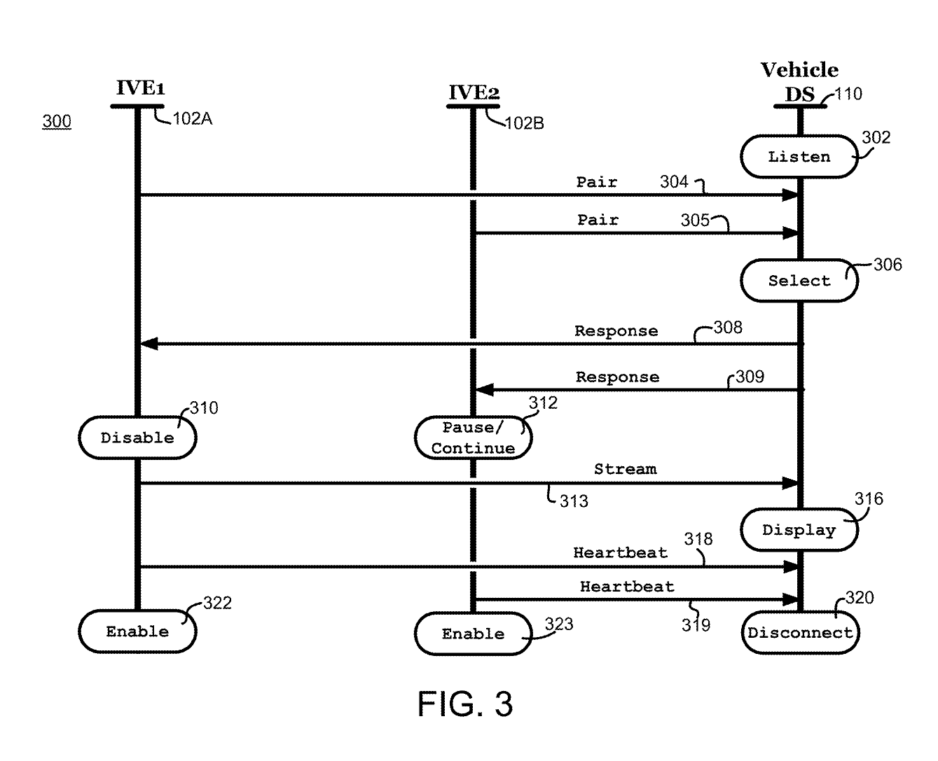

As noted above, various embodiments could consider multiple IVE devices 102A-B operated by multiple users that may be present in proximity to the same vehicle. With reference now to FIG. 3, an example of a process 300 that could be used to manage communications between a display system 110 and two or more IVE devices 102A-B is shown.

As noted above, vehicle display system 110 suitably monitors for IVE devices 102A-B that may be present within the physical proximity of the vehicle (function 302). Proximity may be defined by the range of wireless signaling protocols used to communicate with the IVE 102A-B in many embodiments. When one or more IVE devices 102A-B are discovered, then the display system 110 attempts to pair with the devices 102A-B as desired (functions 304, 305). Note that the IVE devices 102A-B may not come into contact with the vehicle at the same time; in practice, the devices 102A-B may be discovered minutes, hours or even days apart from each other, depending upon the vehicle and the implementation.

In the example illustrated in FIG. 3, a single display 120 presents data associated with one IVE 102A-B or another. When multiple IVEs 102A-B are discovered in such embodiments, then it may be desirable to allow a selection of which IVE 102A-B should provide data to the display 120 (function 306). If multiple IVE users are riding in a vehicle, for example, it may be beneficial to determine which user is the vehicle operator or which user is in the best physical position for viewing the display 130. Passengers in a vehicle may wish to continue using their IVE displays, for example, rather than transferring to a vehicle display 120 that is better used by the driver of the vehicle. The selection 306 may take place in any manner; various embodiments could allow selection via inputs associated with display system 110, whereas other embodiments may simply operating on a first-come-first-served manner, or any other selection basis as desired.

In the example of FIG. 3, IVE 102A is selected to pair with the vehicle display 120. Pairing status may be relayed to each IVE 102A-B via messages 308, 309 (respectively), which may be sent directly to each IVE 102A-B via interface 114 as desired. The IVE 102A that is paired with the vehicle display 120 suitably disables its own display (function 310), and forwards data to the display system 110 as desired (function 313). IVE 102B, which is not selected to pair with the primary vehicle display 120 in this example, may be managed in any appropriate manner (function 312). In various embodiments, IVE 102B may provide data to a secondary display within the vehicle, or the IVE 102B may simply continue to operate normally, with visual outputs provided to the display within the IVE 102B itself.

Imagery may be generated and presented on the vehicle display 120 in any manner (function 316). As noted above, imagery presented on the display 120 may be generated on the paired IVE 102A or on the display system 110 based upon information received from IVE 102A via interface 114 and/or information received via a separate interface 112. Even though FIG. 3 shows a video stream 313 provided to system 110 from IVE 102A, then, equivalent embodiments could generate the stream at system 110 and/or could receive a similar stream 313 from another source on network 105 or elsewhere.

In the example of FIG. 3, display system 110 remains in communication with each IVE 102A-B even though only one IVE 102A is actively paired with the vehicle display 120. While other embodiments could equivalently discontinue communications with non-paired IVEs 102B, maintaining a connection allows the display system 110 to conveniently switch the presentation on display 120 at a later time, if desired.

Communications may be maintained though heartbeat messages 318, 319, as described above, or in any other manner. When heartbeat messages and/or other data is no longer received from an IVE 102A-B, then the vehicle display system 110 suitably disconnects the IVE 102 A-B as desired. At that point another IVE 102 may be selected, if one is available, or the display could remain idle, or content from other sources (e.g., content from server 125) could be provided. When the IDE 102A-B is no longer in proximity to the vehicle (or when the IDE is no longer paired to the display system no), then the IDE is released and presentation of content on the IDE's display can resume as desired (functions 322, 323).

Generally speaking, the various steps of processes 200 and 300 may be carried out with any sort of hardware, software and/or firmware logic within system 100. Process 200 may be carried out, for example, by a vehicle display system 110 (FIG. 1) operating in conjunction with any appropriate IVEs 102A-B and/or networked services 104,125 as appropriate. In various embodiments, the various steps of processes 200 and 300 are carried out in response to software or firmware instructions stored in a memory, or on a disk drive and/or other storage associated with display system 110, IVE 102A-B, and/or servers 104 or 125. Such instructions may be executed by any processor and/or other processing features within display system 110, IVEs 102A-B, servers 104, 125 and/or the like. The particular means used to implement each of the various functions shown in FIGS. 2 and 3, then, could be any sort of processing hardware executing conventional software logic in any format.

The various processes and structures set forth herein could therefore provide an effective solution to the challenge of presenting IVE data within a vehicle without distracting a driver or operator of the vehicle. As an IVE is discovered within communications range of the vehicle, the vehicle display system is able to automatically pair with the IVE so that presentation of some or all of the content presented on the IVE is instead presented on a vehicle display.

The term “exemplary” is used herein to represent one example, instance or illustration that may have any number of alternates. Any implementation described herein as exemplary is not necessarily to be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A method executable by a vehicle display system to provide imagery intended for an integrated virtual environment (IVE) device on a display of a vehicle, the method comprising:
detecting that the IVE device is in physical proximity to the vehicle; and
when the IVE device is in physical proximity to the vehicle:
providing a first message to the IVE device to thereby temporarily disable presentation of data on an IVE display of the IVE device; and
directing the presentation of the data on the display of the vehicle instead of on the IVE display.

2. The method of claim 1 further comprising, when the IVE device is in proximity to the vehicle, receiving heartbeat messages from the IVE device to thereby verify that the IVE device is still in proximity to the vehicle.

3. The method of claim 2 further comprising discontinuing the presentation of the data on the display of the vehicle when the IVE device is no longer in proximity to the vehicle.

4. The method of claim 1 wherein the detecting comprises detecting a plurality of IVE devices in physical proximity to the vehicle and resolving which of the plurality of IVE devices is to be disabled.

5. The method of claim 4 wherein the data presented on the display of the vehicle is obtained from the disabled IVE device.

6. The method of claim 1 further comprising, when the IVE device is in physical proximity to the vehicle, receiving the data from the IVE device.

7. The method of claim 1 further comprising, when the IVE device is in physical proximity to the vehicle, performing a handoff so that data from a content source that was previously directed to the IVE device is instead provided directly to the vehicle display system.

8. The method of claim 7 wherein the data from the content source is received at the vehicle display system via a communications interface that is separate from an interface used to communicate with the IVE device.

9. The method of claim 7 further comprising interacting with a backend service that obtains the data from the content source via a network and that relays the obtained data to the vehicle display system via the separate communications interface.

10. The method of claim 1 wherein the detection comprises identifying that the IVE device is able to pair with a wireless receiver of the vehicle display system.

11. A display management system to provide imagery on a display of a vehicle, the display management system comprising:
a communications interface configured to receive data communications signals from an antenna; and
a controller configured to identify an integrated virtual environment (IVE) device in physical proximity to the vehicle and, when the IVE device is in physical proximity to the vehicle, to instruct the IVE to disable its display and to instead provide content otherwise presented on the IVE as the imagery for presentation on the display of the vehicle.

12. The system of claim 11 further comprising, when the IVE device is in proximity to the vehicle, the controller is configured to receive heartbeat messages from the IVE device to thereby verify that the IVE device is still in proximity to the vehicle.

13. The system of claim 11 wherein the controller is further configured to discontinue the presentation of the data on the display of the vehicle when the IVE device is no longer in proximity to the vehicle.

14. The system of claim 11 wherein the controller is further configured to detect a plurality of IVE devices in physical proximity to the vehicle and resolving which of the plurality of IVE devices is to be disabled.

15. The system of claim 14 wherein the data presented on the display of the vehicle is obtained from the disabled IVE device.

16. The system of claim 11 wherein the controller is further configured to receive the data from the IVE device when the IVE device is in physical proximity to the vehicle.

17. The system of claim 11 wherein the controller is further configured to perform a handoff when the IVE device is in physical proximity to the vehicle so that data from a content source that was previously directed to the IVE device is instead provided directly to the vehicle display system.

18. The system of claim 17 further comprising a wide area network interface separate from separate from the communications interface, wherein the wide area network interface is configured to receive the data from the content source.

19. The system of claim 17 wherein the controller is further configured to interact with a backend service that obtains the data from the content source via a network and that relays the obtained data to the vehicle display system via the separate communications interface.

20. The system of claim 11 wherein the controller is configured to identify that the IVE device is able to pair with a wireless receiver of the vehicle display system.
